(19) United States
(12) Patent Application Publication
(10) Pub. No.: US 2025/0381928 A1
(43) Pub. Date: Dec. 18, 2025

(54) BUMPER ASSEMBLY FOR A VEHICLE

(71) Applicant: ARB Corporation Limited, Kilsyth (AU)

(72) Inventors: John Desmond CLARK, Kilsyth (AU); Robert Nurwicaksono HADISUTANTO, Kilsyth (AU); John Gilbert STUBBE, Kilsyth (AU); Ryan Warren Lee OLDFIELD, Kilsyth (AU); Nicholas David Laidlaw LANGLEY, Kilsyth (AU); Gavin COLGAN-SMITH, Kilsyth (AU)

(21) Appl. No.: 18/903,845

(22) Filed: Oct. 1, 2024

(30) Foreign Application Priority Data
Jun. 13, 2024 (AU) 2024901795

(51) Int. Cl. B60R 19/48; B60R 19/50; B66D 1/36

(52) U.S. Cl. CPC B60R 19/48; B66D 1/36; B60R 2019/486; B60R 2019/505

(57) ABSTRACT

Bumper assembly (10) for a vehicle. The assembly (10) includes: a chassis (12) configured to be mounted to the front of the vehicle, the chassis (12) having a spaced pair of wing members (14) shaped to mate with the fenders of the vehicle, and defining a void (16) between the wing members (14); and an impact absorbing member (18) releasably mountable to the chassis (12), the impact absorbing member (18) configured to be secured between the wing members (14) to cover the void (16) and inhibit relative movement of the wing members (14), and be arranged to absorb frontal impacts during use.

### CROSS-REFERENCE TO RELATED APPLICATIONS

This application claims priority from Australian provisional patent application no. 2024901795, filed on 13 Jun. 2024, the disclosure of which is incorporated herein in its entirety.

### TECHNICAL FIELD

The present disclosure relates generally to vehicle bumpers, and particularly to bumper assemblies for vehicles intended for driving off-road.

### BACKGROUND

Off-road vehicles (commonly referred to as 4WD or 4×4 vehicles) are typically exposed to challenging terrain and environmental conditions that are not commonly encountered by standard road vehicles. These conditions include, but are not limited to, rocky terrain, steep inclines, mud, vegetation, and wild animals. Traditional vehicle bumpers are primarily designed for absorbing impact in collisions at moderate speeds on roads. Such bumpers may provide little to no functionality in rugged off-road environments, particularly when colliding with large animals, such as cows, deer, moose, or kangaroos.

Bull bars, also known as nudge bars or roo bars, are specialized bumper structures developed to enhance the durability and functionality of vehicles used in off-road conditions. These products are designed not only to protect the front of the vehicle from collisions with large obstacles, such as rocks or fallen trees, but also to carry accessories for assisting off-road travel, such as winches, auxiliary lights, and tow hooks.

Despite the availability of various designs, existing bull-bar assemblies often suffer from several drawbacks. Common issues include excessive weight, which impacts the vehicle's fuel efficiency and handling, inadequate integration with vehicle systems and sensors, such as radar or parking sensors, and limited customization options to meet specific user needs or preferences. Furthermore, many current designs do not consider installation and maintenance of accessories, resulting in limited access to accessories fitted to the bull bar, and/or complex procedures to add or remove accessories.

Any discussion of documents, acts, materials, devices, articles or the like which has been included in the present specification is not to be taken as an admission that any or all of these matters were common general knowledge in the field relevant to the present disclosure as it existed before the priority date of each of the appended claims.

### SUMMARY

Disclosed is a bumper assembly for a vehicle. The bumper assembly includes a chassis configured to be mounted to the front of the vehicle, with wing members shaped to mate with the fenders of the vehicle and defining a void between them. The assembly also includes an impact absorbing member releasably mountable to the chassis and configured to be secured between the wing members to cover the void and inhibit relative movement of the wing members, and arranged to absorb frontal impacts during use.

The wing members may be arranged so that the void separates an operatively bottom portion of each wing member, and the impact absorbing member may be configured to attach between the bottom portions.

The impact absorbing member may be shaped to wrap around an operatively front portion of the chassis and an operatively bottom portion of the chassis.

The impact absorbing member may be shaped to extend operatively forward from the chassis.

The impact absorbing member may define a recessed operatively front region to form rim extending at least partially around a top and sides of the front region.

The impact absorbing member may define a front and opposed sides extending away from the front, and each side be arranged to mate to one of the wing members, and the bumper assembly may also include a plurality of fasteners, where each fastener securable between one of the sides and one of the wing members.

The chassis may have a central portion extending between the wing members, and the impact absorbing member may be mountable to the chassis to be operatively below the central portion.

The central portion may extend between an operatively top portion of each wing member, and the impact absorbing member may be mountable to the chassis to be spaced from and below the central portion.

The bumper assembly may include a grille mountable between the central portion and the impact absorbing member.

The bumper assembly may include one or more driving lights mountable between the central portion and the impact absorbing member.

Each wing portion may define an insert aperture, and the assembly may include a pair of inserts mountable within the insert apertures, each insert configured to surround a fog lamp or duct air flow through the insert aperture.

The impact absorbing member may include a stone guard portion arranged to extend partway under the vehicle.

The bumper assembly may also include a pair of recovery point members secured to the chassis, and the impact absorbing member be shaped to provide access to the recovery point members.

The bumper assembly may also include an accessory cradle mountable to the chassis to extend at least partially across the void, where the cradle is configured to carry one or more accessories, and the impact absorbing member may be configured to cover the accessory cradle and be removable from the chassis to provide access to the accessory cradle.

Also disclosed is a bumper assembly for a vehicle, where the assembly includes a chassis configured to be mounted to the vehicle, the chassis having a spaced pair of wing members shaped to mate with the fenders of the vehicle, and defining a void between the wing members, an accessory cradle mountable to the chassis to extend at least partially across the void, the accessory cradle configured to carry one or more accessories, and an impact absorbing member releasably mountable to the chassis to substantially cover the void and the accessory cradle, and be arranged to absorb frontal impacts during use, the impact absorbing member configured to be removable from the chassis to provide access to the accessory cradle.

The impact absorbing member may be releasably mountable to the accessory cradle.

The accessory cradle may be configured to carry a winch, and the impact absorbing member define an aperture dimensioned to receive a winch cable, and carry a hawse fairlead arranged about the aperture.

The impact absorbing member may be configured to be secured between the wing members to inhibit relative movement of the wing members.

Throughout this specification the word “comprise”, or variations such as “comprises” or “comprising”, will be understood to imply the inclusion of a stated element, integer or step, or group of elements, integers or steps, but not the exclusion of any other element, integer or step, or group of elements, integers or steps.

It will be appreciated embodiments may comprise steps, features and/or

integers disclosed herein or indicated in the specification of this application individually or collectively, and any and all combinations of two or more of said steps or features.

### BRIEF DESCRIPTION OF DRAWINGS

Embodiments will now be described by way of example only with reference to the accompany drawings in which:

FIGS. 1 to 3 are perspective, front, and side views, respectively, of a first embodiment of a bumper assembly for a vehicle, where the assembly has an impact absorbing member mounted to a chassis;

FIG. 4 is a perspective view of the assembly illustrated in FIGS. 1 to 3 with the impact absorbing member shown separated from the chassis;

FIGS. 5 and 6 are perspective and front views of the assembly shown in the previous figures, where the impact absorbing member is removed;

FIG. 7 is a front view of the assembly shown in the previous figures with an accessory cradle removed;

FIG. 8 is a front view of a second embodiment of a bumper assembly for a vehicle;

FIG. 9 is a front view of a third embodiment of a bumper assembly for a vehicle;

FIG. 10 is a front view of a fourth embodiment of a bumper assembly for a vehicle;

FIGS. 11 and 12 are perspective views of a fifth embodiment of a bumper assembly for a vehicle where the assembly has an impact absorbing member mounted to (FIG. 11), and spaced from (FIG. 12), a chassis; and

FIG. 13 is a front view of the embodiment shown in FIGS. 11 and 12, where the impact absorbing member is removed from the chassis.

### DESCRIPTION OF EMBODIMENTS

In the drawings, reference numeral 10 generally designates a bumper assembly 10 for a vehicle (not illustrated). The assembly 10 includes: a chassis 12 configured to be mounted to the front of the vehicle, the chassis 12 having a spaced pair of wing members 14 shaped to mate with the fenders of the vehicle, and defining a void 16 between the wing members 14; and an impact absorbing member 18 releasably mountable to the chassis 12, the impact absorbing member 18 configured to be secured between the wing members 14 to cover the void 16 and inhibit relative movement of the wing members 14, and be arranged to absorb frontal impacts during use.

The bumper assembly 10 is generally configured for use with vehicles intended for driving off-road and may be used as a bull bar. It will however be appreciated that the assembly 10 is also appropriate for on-road use. The assembly 10 has particular utility for off-road applications as it is configurable to carry one or more of a range of accessories, such as winches, lights, radio antenna, radar sensors, and the like, and provide access to such accessories to enhance installation and maintenance, as discussed in greater detail below.

The assembly 10 includes two main structural components, being the chassis 12, which is intended to be fixedly mounted to the front of the vehicle, and the impact absorbing member 18 which is removably mountable to the chassis 12. The impact absorbing member 18 is typically configured to be secured to the chassis 12 to inhibit relative movement of the spaced chassis portions, being the wing members 14. The configuration of the assembly 10 having these two structures 12, 18 is contrary to prior art approaches, where a bull bar typically comprises a unitary chassis structure. This approach has been employed for many years to reduce manufacturing complexity and achieve appropriate structural integrity to survive significant impact forces, for example, due to colliding with a rock or animal. The assembly 10 achieves the appropriate structural integrity with a two-piece construction, which can advantageously allow removal and replacement of the impact absorbing member 18 should it be damaged in a collision, and/or greater customisation through contrasting aesthetic and/or functional characteristics of the chassis 12 and impact absorbing member 18.

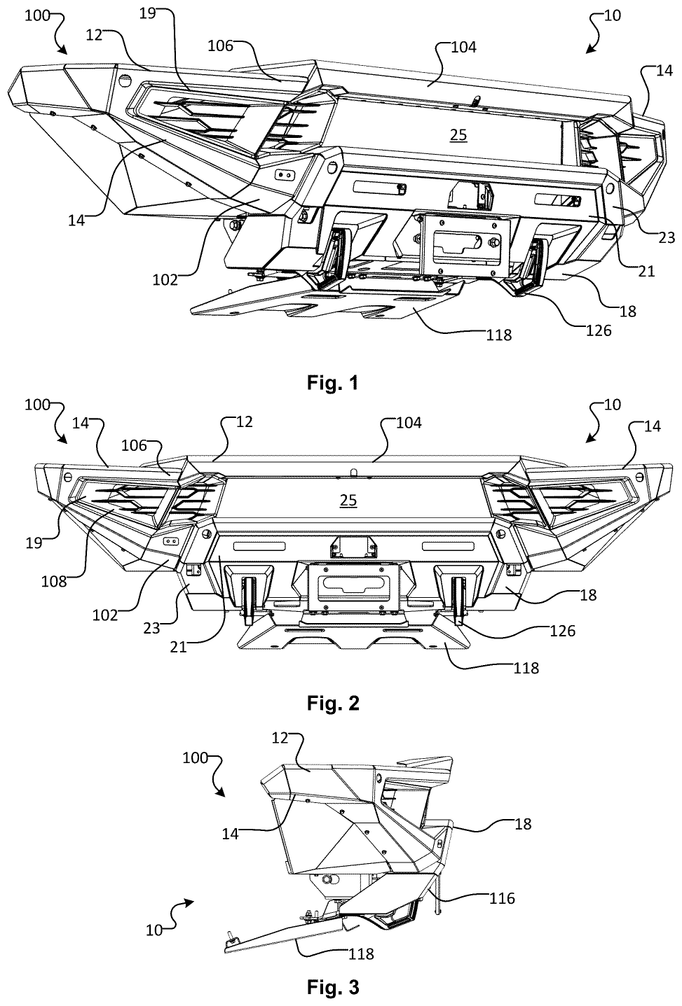

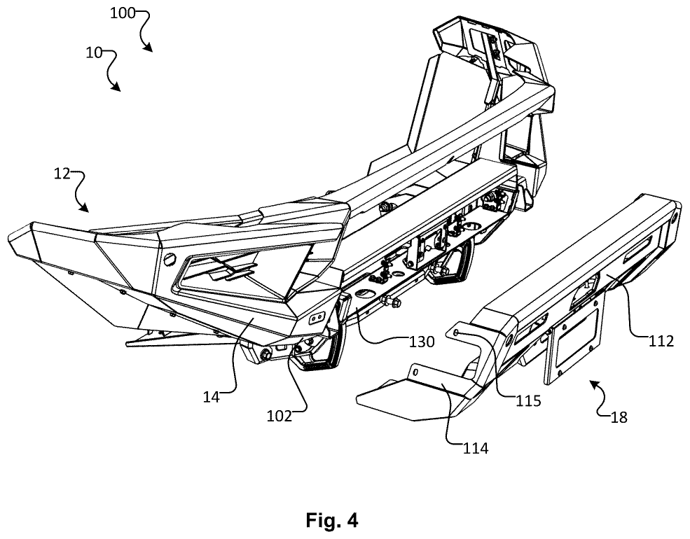

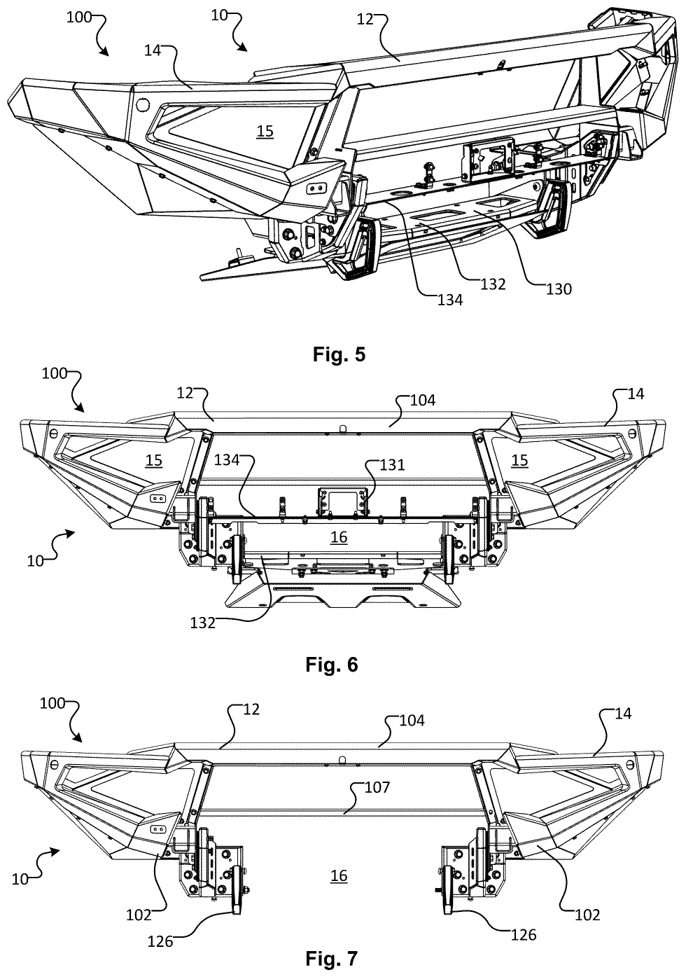

FIGS. 1 to 3 show a first embodiment 100 of the bumper assembly 10, where the assembly 10 has the impact absorbing member 18 mounted to the chassis 12. FIG. 4 shows the impact absorbing member 18 disconnected and spaced from the chassis 12. FIGS. 5 to 7 show the impact absorbing member 18 removed from the assembly 100 to allow access to the void 16.

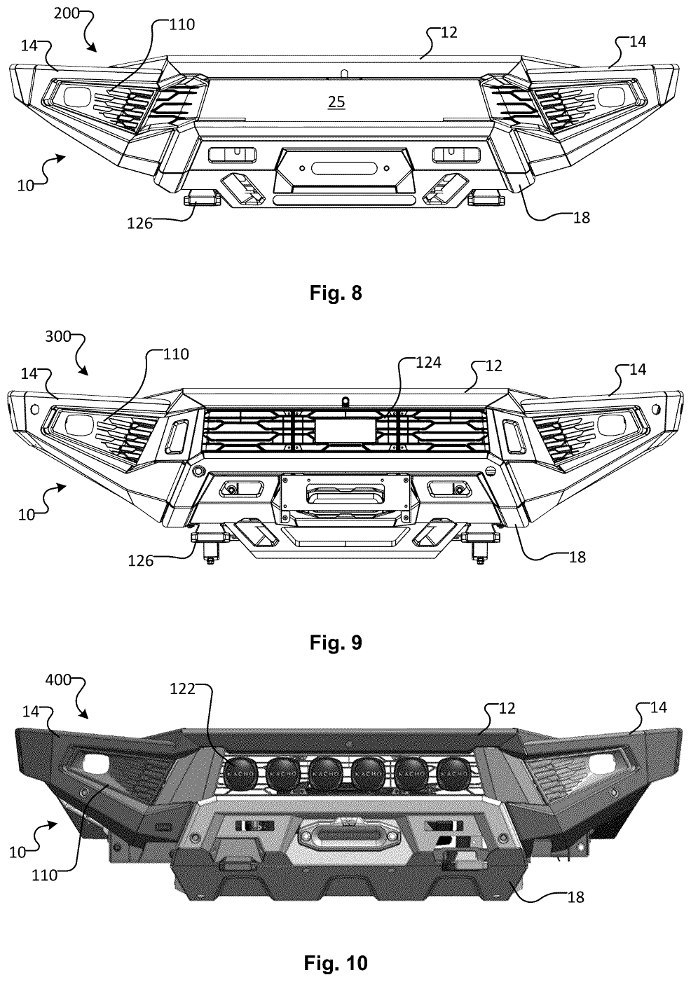

FIGS. 8 to 13 show alternative embodiments 200, 300, 400, 500 of the bumper assembly 10 which may share features with the first embodiment 100. It will be appreciated that common reference numerals indicate common features unless stated otherwise.

Best shown in FIG. 7, the spaced wing members 14 are arranged to define the void 16 therebetween. In this embodiment 100, the wing members 14 are arranged such that the void 16 entirely separates an operatively bottom portion 102 of each wing member 14, in other words, there is a gap between the bottom portions 102. The impact absorbing member 18 is configured to attach between the bottom portions 102 to inhibit relative movement, effectively acting as a tie between the wing members 14. This arrangement of the void 16 allows fitting accessories, or other structures to carry accessories, between the wing members 14 and behind the impact absorbing member 18, as described below. It will be appreciated that, in other embodiments, the wing members 14 may be alternatively shaped such that operatively top portions are separated by the void 16, and the impact absorbing member 18 is arrangeable to cover between the top portions.

Each wing member 14 is shaped to generally conform to the geometry of the fenders of the vehicle so that the appearance of the chassis 12 blends, or complements, the appearance of the front end of the vehicle. The assembly 10 is typically configured to be fitted to a specific vehicle model, meaning that the shape and dimensions of the wing members 14, as well as other aspects of the chassis 12 and impact absorbing member 18, are adapted accordingly.

In the illustrated embodiment 100, the wing members 14 are joined by a central portion, configured as a bar 104. The bar 104 bridges between operatively top portions 106 of the wing members 14. A brace 107 is spaced below the bar 104 to extend between the wing members 14. While the bar 104 and the brace 107 couple the wing members 14, these components provide limited strength to the chassis 12 structure. The assembly 100 is configured so that fitting the impact absorbing member 18 between the wing members 14 rigidly couples the members 14 to provide an appropriately robust structure for use in off-road driving. It will be appreciated that in other embodiments (not illustrated), the bar 104 or brace 107 may be absent such that the structure connecting the wing members 14 is minimised, or in yet other embodiments (not illustrated), both the bar 104 and brace 107 may be absent such that the wing members 14 are entirely separate and only joined by the impact absorbing member 18, when fitted. In yet other embodiments (not illustrated), the central portion is shaped and/or arranged to be more substantial to join between greater portions of the wing members 14. For example, the central portion may comprise a strut (not illustrated) joining between operatively central portions of the wing members 14.

Each wing member 14 defines an insert aperture 15 for receiving an insert 19. In the embodiment shown in FIGS. 1 to 3, each insert 19 is configured as an air duct 108 configured to direct air through the aperture 15 to flow into the engine bay of the vehicle, during use. In other embodiments, such as the embodiments 200, 300, 400 shown in FIGS. 8 to 10, the insert 19 is configured as a fog light (or foglamp) housing 110 to carry, or provide access to, one of the vehicle's fog lights. It will be appreciated that the insert is configurable in other ways to suit user preferences or functional requirements, such as being a combination of light housing and air duct. In some embodiments (not illustrated), the insert may be a blank mounted to only cover the aperture. In some embodiments, the insert 19 is configured for removably mounting to the wing member 14 to allow replacement or substitution with another insert 19.

The impact absorbing member 18 is mountable to the chassis 12 to inhibit movement of the wing members 14 relative to each other, such as due to tensile, compressive, torque and/or other forces exerted on the bumper assembly 10 during normal use when fitted to the vehicle. In the embodiment 100, the impact absorbing member 18 defines a front 112 and opposed sides 114 extending away, substantially perpendicularly, from the front 112. Each side 114 is arranged to mate to one of the wing members 14. In some embodiments, each side 114 is shaped to slidingly engage a portion of one of the wing members 14.

The assembly 100 also includes a plurality of releasable mechanical fasteners, such as bolts, which are securable between one of the sides 114 and one of the wing members 14. In this embodiment, each side 114 is arranged to couple to one of the suspended lower portions 102 of the wing members 14. Best shown in FIG. 4, each side 114 defines holes 115 to receive the fasteners. This arrangement positions the fasteners in an operatively side-to-side orientation to conceal their appearance. It will be appreciated that, in other embodiments, the fasteners may be accessible and visible from the front 112 of the impact absorbing member 18, should this function or appearance be preferred.

As described above, the impact absorbing member 18 is releasably mountable to the chassis 12. It will be appreciated that securing these components together with mechanical fasteners is only one of a range of suitable approaches. For example, in some embodiments (not illustrated), the impact absorbing member 18 may be shaped to engage the chassis 12 or another component mounted to the chassis 12, such as with hook or tab members, at an operatively bottom or top portion of the impact absorbing member 18, and carry a fastening mechanism at the other of the operatively bottom or top portion, such that operating the fastening mechanism interacts with the chassis 12, such as by clamping or interlocking, to retain the impact absorbing member 18 to the chassis 12.

The impact absorbing member 18 typically defines a recessed front region 21 to form a rim 23 extending at least partially around a top and sides of the front region. The rim 23, in use, is positioned operatively forward of the recessed front region 21 to inhibit obstacles colliding with the recessed region 19, such as to protect other components positioned within the region 19. Shaping the impact absorbing member 18 in this way can also enhance rigidity of the component, providing a stiff peripheral structure.

When mounted to the chassis 12, the impact absorbing member 18 is generally shaped to wrap around an operatively front portion of the chassis 12 and an operatively bottom portion of the chassis 12. Additionally or alternatively, the impact absorbing member 18 is generally shaped to extend operatively forward from the chassis 12, such as to be positioned to absorb frontal impact forces.

Best shown in FIG. 3, in the assembly 100, the impact absorbing member 18 extends forward from the chassis 12 and wraps partway under the chassis 12 to be positioned to absorb impact forces from in front of, and below, the vehicle, such as due to colliding with rocks or tree stumps while driving forwards. A lower portion 116 of the impact absorbing member 18 is shaped to define an angle, in use, with the horizon to enhance the vehicle riding over obstacles which collide with the impact absorbing member 18. This shape is complemented by the arrangement of a stone guard 118 (also known as a bash guard or under panel) mounted to the chassis 12 to be adjacent the impact absorbing member 18 and extend partway under the vehicle, in use. The stone guard 118 is arranged to extend protection under the engine bay of the vehicle and enhance the vehicle riding over obstacles. Both the stone guard 118 and the impact absorbing member 18 may be removably mounted to the chassis 12 to allow being removed and replaced when damaged, or to affect the appearance of the assembly 100. In some embodiments, such as the embodiment 400 shown in FIG. 8, the impact absorbing member 18 may be integrated with the stone guard 118.

The impact absorbing member 18 is typically mountable to the chassis 12 to be operatively below the central portion joining between the wing members 14, and generally mounted to define a space 25 between the impact absorbing member 18 and the central portion, such as the bar 104. The space 25 may be configured to receive one or more accessories, such as driving lights 122, radar sensor, and/or receive a grille 124, such as shown in the embodiments 300, 400 illustrated in FIGS. 9 and 10. The accessories are configurable to be releasably mountable such as to allow replacement or substitution with other accessories.

Best shown in FIGS. 1 and 2, the impact absorbing member 18 is shaped to provide access to a pair of recovery point members 126 secured to, or otherwise carried by, the chassis 12 or, in some embodiments, carried by the vehicle. As shown in FIG. 7, the recovery point members 126 may be fixedly mounted to the bumper chassis 12 to be spaced from each other at opposed sides of the void 16 defined by the chassis 12. The members 126 provide robust attachment points for securing a tow hook or the like to allow towing or otherwise pulling the vehicle, such as by coupling a cable to one of the members 126 to withdraw the vehicle from a ditch.

Best shown in FIGS. 4 to 6, the assembly 100 may include an accessory cradle 130 fixedly mountable to the chassis 12 to be arranged, in use, behind the impact absorbing member 18. The cradle 130 is configured to carry one or more accessories, such as a winch, driving light, and/or sensors. For example, in the illustrated embodiment, the cradle 130 includes a radar sensor mount 131 for carrying a radar sensor. Typically, the cradle 130 is configured to carry a winch mechanism (not illustrated). The arrangement of the cradle 130 relative to the impact absorbing member 18 means that removal of the member 18 from the chassis 12 allows access to the cradle 130 and the accessories carried thereon. Where the cradle 130 is configured for carrying a winch, this arrangement can be particularly useful to assist installing, removing, and/or maintaining the winch, as the impact absorbing member 18 can be readily removed to enhance access to the winch. For some applications, winches need to be regularly maintained, for example, when the winch is often exposed to, or submerged in, water, meaning that the impact absorbing member 18 is regularly removed by a user or mechanic to conduct routine maintenance of the winch.

In the assembly 100, the cradle 130 comprises a tray 132 configured for carrying a winch, and a brace 134. The tray 132 and the brace 134 are each mounted to the chassis 12 between the wing members 14. The tray 132 is specified to be sufficiently strong to carry the winch, which typically weighs around 30-50 kg, and arrange the winch to be proximal to the impact absorbing member 18 so that the winch cable can be passed through and away from the front of the vehicle. It will be appreciated that, in other embodiments, such as shown in FIGS. 8 to 10, the cradle 130 may be alternatively configured, such as by omitting the brace 134.

The chassis 12 and impact absorbing member 18 are typically produced from sheet metal which is formed, such as by pressing and/or bending, and/or welded to define the required geometry. In some embodiments, the chassis 12 and impact absorbing member 18 are produced from non-metallic material, such as carbon fibre or other composite material, for example, to minimise weight, such as for racing applications. In yet other embodiments, the chassis 12 is formed from a first material and the impact absorbing member 18 is formed from a second, different material to affect physical and/or aesthetic properties, such as to enhance weight, strength, and the like. For example, the chassis 12 may be formed from a rigid metal and the impact absorbing member 18 may be formed from a resiliently deformable polymer to allow absorbing force in a collision and then returning to its original shape. In some embodiments, the chassis 12 has a first finish, such as a first colour powder coating, and the impact absorbing member 18 has a second, different finish, such as a second colour powder coating, to define a visual contrast between the components.

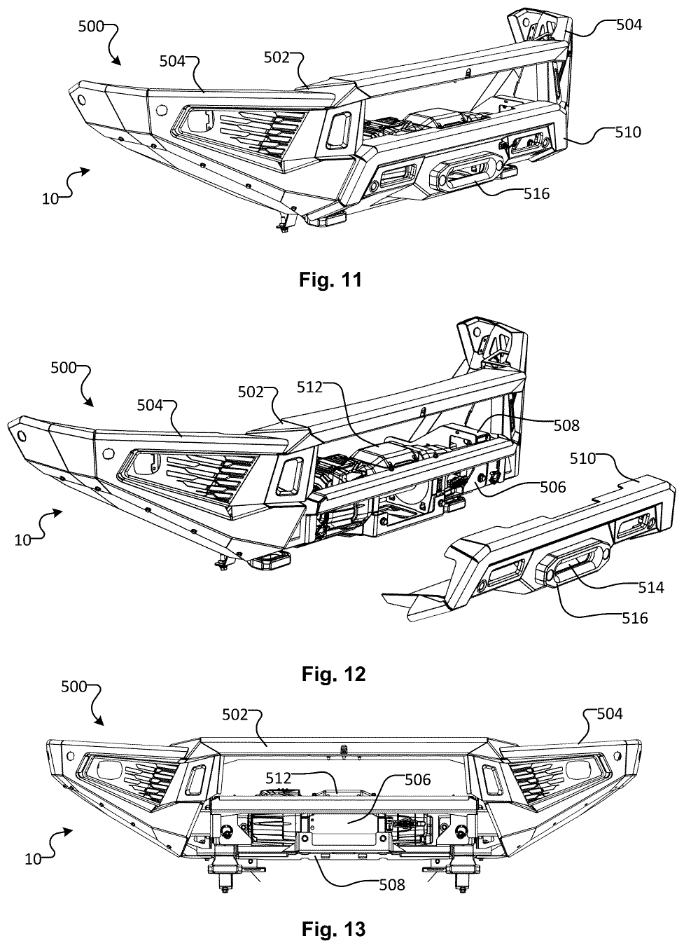

FIGS. 11 to 13 show an alternative embodiment 500 of the bumper assembly 10, where the assembly 500 includes: a chassis 502 configured to be mounted to the vehicle, the chassis 502 having a spaced pair of wing members 504 shaped to mate with the fenders of the vehicle, and defining a void 506 between the wing members 504; an accessory cradle 508 mountable to the chassis 502 to extend at least partially across the void 506, the accessory cradle 508 configured to carry one or more accessories; and an impact absorbing member 510 releasably mountable to the chassis 502 to substantially cover the void 506 and the accessory cradle 508, and be arranged to absorb frontal impacts during use, the impact absorbing member 508 configured to be removable from the chassis 502 to provide access to the accessory cradle 508.

In this embodiment 500, the impact absorbing member 508 may be configured to releasably mount to the accessory cradle 508, in addition to the chassis 502, such as be securing one or more releasably fasteners between the member 508 and the cradle 508. This configuration can enhance the structural integrity of the assembly 500.

As shown in FIGS. 11 to 13, the cradle 508 is configurable to carry a winch 512. In such embodiments, the impact absorbing member 510 defines a cable aperture, in this embodiment in the form of a slot 514 dimensioned to receive a winch cable (not shown), and typically carries a hawse fairlead 516 arranged about the slot 514 to assist the cable running smoothly through the slot 514 and/or minimise wear on the cable and/or the impact absorbing member 510.

The arrangement of the cradle 508 relative to the impact absorbing member 510 means that removal of the member 510 allows access to the cradle 508 and the accessories carried thereon, such as the winch 512. When carrying the winch 512, this arrangement can be particularly useful to assist installation, removal, and/or maintenance of the winch 512, as the impact absorbing member 510 can be readily removed, such as be user, to enhance access to the winch 512. For some applications, winches need to be regularly maintained, for example, when the winch 512 is frequently exposed to, or submerged in, water, meaning that the impact absorbing member 510 is regularly removed by a user or mechanic to conduct routine maintenance of the winch 512.

Use of the bumper assembly 10 involves, initially, removing the factory-fitted bumper from the vehicle, and mounting the chassis 12 to the vehicle so that the wing members 14 are substantially aligned with the fenders of the vehicle. This generally involves securing various fasteners through points in the vehicle and the chassis 12. The impact absorbing member 18 is then mounted to the chassis 12 to cover across the void 16. This involves securing various fasteners through points in the chassis 12 and the impact absorbing member 18.

Once fitted, the impact absorbing member 18 may be readily removed, by a user or a mechanic, to allow access to the void 16 or regions of the chassis 12 about the void 16. This may allow, for example, access to the engine bay of the vehicle which can enhance maintenance of the vehicle, and/or enhance maintenance of the assembly 10.

The bumper assembly 10 is configurable to carry a range of accessories, such as winches, lights, radio antenna, radar sensors, and the like, and provide access to such accessories by removal of the impact absorbing member 18 from the chassis 12, while the chassis 12 remains mounted to the vehicle. This may enhance installation and maintenance of the accessories.

The bumper assembly 10 is configured to achieve appropriate structural integrity with a two-piece construction. This can advantageously allow removal and replacement of the impact absorbing member 18 should it be damaged in a collision, avoiding having to replace the entire assembly 10. The configuration may allow greater customization through contrasting aesthetic and/or functional characteristics of the chassis 12 and impact absorbing member 18.

The impact absorbing member 18 may be shaped to extend forward from the chassis 12, and may wrap partway under the chassis 12, to be positioned to absorb impact forces from in front of, and below, the vehicle.

The assembly 10 may include an accessory cradle 130, 508, fixedly mountable to the chassis 12 to be arranged, in use, behind the impact absorbing member 18, 510. The cradle 130, 508 is configured to carry one or more accessories, such as a winch, driving light, and/or sensors. The cradle 130, 508, in combination with the chassis 12, and impact absorbing member 18, 510 may provide a modular assembly which is configurable as any of a wide range of different products formed from a limited kit of parts.

It will be appreciated by persons skilled in the art that numerous variations and/or modifications may be made to the above-described embodiments, without departing from the broad general scope of the present disclosure. The present embodiments are, therefore, to be considered in all respects as illustrative and not restrictive.

1. A bumper assembly for a vehicle, the assembly including:
a chassis configured to be mounted to the front of the vehicle, the chassis having a spaced pair of wing members shaped to mate with the fenders of the vehicle, and defining a void between the wing members, and
an impact absorbing member releasably mountable to the chassis, the impact absorbing member configured to be secured between the wing members to cover the void and inhibit relative movement of the wing members, and be arranged to absorb frontal impacts during use.

2. The bumper assembly of claim 1, wherein the wing members are arranged such that the void separates an operatively bottom portion of each wing member, and the impact absorbing member is configured to attach between the bottom portions.

3. The bumper assembly of claim 1, wherein the impact absorbing member is shaped to wrap around an operatively front portion of the chassis and an operatively bottom portion of the chassis.

4. The bumper assembly of claim 1, wherein the impact absorbing member is shaped to extend operatively forward from the chassis.

5. The bumper assembly of claim 1, wherein the impact absorbing member defines a recessed operatively front region to form rim extending at least partially around a top and sides of the front region.

6. The bumper assembly of claim 1, wherein the impact absorbing member defines a front and opposed sides extending away from the front, and each side is arranged to mate to one of the wing members, and further including a plurality of fasteners, each fastener securable between one of the sides and one of the wing members.

7. The bumper assembly of claim 1, wherein the chassis has a central portion extending between the wing members, and the impact absorbing member is mountable to the chassis to be operatively below the central portion.

8. The bumper assembly of claim 7, wherein the central portion extends between an operatively top portion of each wing member, and the impact absorbing member is mountable to the chassis to be spaced from and below the central portion.

9. The bumper assembly of claim 8, further including a grille mountable between the central portion and the impact absorbing member.

10. The bumper assembly of claim 8, further including one or more driving lights mountable between the central portion and the impact absorbing member.

11. The bumper assembly of claim 1, wherein each wing portion defines an insert aperture, and further including a pair of inserts mountable within the insert apertures, each insert configured to at least one of: surround a foglamp; and duct air flow through the insert aperture.

12. The bumper assembly of claim 1, wherein the impact absorbing member includes a stone guard portion arranged to extend partway under the vehicle.

13. The bumper assembly of claim 1, further including a pair of recovery point members secured to the chassis, and wherein the impact absorbing member is shaped to provide access to the recovery point members.

14. The bumper assembly of claim 1, further including an accessory cradle extending between the wing members, the accessory cradle configured to carry one or more accessories, and the impact absorbing member is configured to cover the accessory cradle and be removable from the chassis to provide access to the accessory cradle.

15. A bumper assembly for a vehicle, the assembly including:
a chassis configured to be mounted to the vehicle, the chassis having a spaced pair of wing members shaped to mate with the fenders of the vehicle, and defining a void between the wing members,
an accessory cradle mountable to the chassis to extend at least partially across the void, the accessory cradle configured to carry one or more accessories, and
an impact absorbing member releasably mountable to the chassis to substantially cover the void and the accessory cradle, and be arranged to absorb frontal impacts during use, the impact absorbing member configured to be removable from the chassis to provide access to the accessory cradle.

16. The bumper assembly of claim 15, wherein the impact absorbing member is releasably mountable to the accessory cradle.

17. The bumper assembly of claim 15, wherein the accessory cradle is configured to carry a winch, and the impact absorbing member defines an aperture dimensioned to receive a winch cable, and carries a hawse fairlead arranged about the aperture.

18. The bumper assembly of claim 15, wherein the impact absorbing member is configured to be secured between the wing members to inhibit relative movement of the wing members.
